(19) United States
(12) Patent Application Publication
(10) Pub. No.: US 2024/0129051 A1
(43) Pub. Date: Apr. 18, 2024

(54) RENDERING ADDITIONAL CONTENT FOR A STREAMED PIECE OF AUDIO CONTENT BY USING WATERMARK-BASED IDENTIFICATION

(71) Applicant: SonoBeacon GmbH, Wismar (DE)

(72) Inventor: Danilo Jacob, Hamburg (DE)

(73) Assignee: SonoBeacon GmbH, Wismar (DE)

(21) Appl. No.: 18/547,676

(22) PCT Filed: Feb. 23, 2021
(86) PCT No.: PCT/EP2021/054432

§ 371 Date: Aug. 23, 2023

(51) Int. Cl. H04H 20/86

(52) U.S. Cl. CPC H04H 20/86; G10L 19/018; H04H 2201/50

(57) ABSTRACT

The present invention refers to a method and a system for identifying by an identifying application, a specific piece of audio content played back by a streaming application based on modulating the specific piece of audio content with an audio watermark comprising an identification number. In response to said identification, additional content corresponding to the specific piece of audio content is rendered on a mobile device of a user. The present invention further discloses various details regarding the way the audio watermark is modulated onto a carrier signal given by the piece of audio content and regarding how the process of identifying a specific piece of content is performed which allows to significantly increase the reliability, speed and security of such a method and system based on the watermarking technology.

### TECHNICAL FIELD

The present disclosure relates to methods and systems for identifying a specific piece of audio content based on an audio watermark and dynamically providing additional content related to the identified piece of audio content.

### BACKGROUND

Near-field communication based on sending and receiving encoded acoustic audio signals in both the audible and the inaudible frequency range for providing additional, customized content has been used in the art for a while now. In said methods, audio signals are first marked with audio watermarks that are not recognizable by human beings and which unambiguously identify a piece of content and are subsequently broadcasted to mobile devices located in direct vicinity. The mobile devices receive said audio signals via their microphones and are further able to retrieve the additional information from a database located on a server based on identifying the audio watermark modulated onto the received audio signal. It is pointed out that throughout this description, the term “audio signal” is used in its specific meaning of “acoustic audio signal”.

Vendors and service providers have especially taken advantage of this method of communication with customers being physically present and thus being able to provide them with up-to-date information and customized offers taking into account the customers' specific context. Moreover, audio signals comprising watermarks captured by the microphone of a mobile device from the ambient environment have also been used to enhance the accuracy of indoor navigation, since satellite-based navigation systems such as GPS generally do not work well in indoor environments.

However, the technology of marking a carrier audio signal with a watermark comprising further information can be readily applied to a wide field of further use cases. Particularly, the area of streaming digital contents, which is becoming more and more important today due to the great success of video and audio streaming platforms such as Spotify, Netflix, iTunes, Amazon Prime, youtube etc. is predestined for applying said technology, because audio signals in the audible range that could be used as carrier signals are readily available.

Hence, it would be possible to provide streamed audio content with additional content corresponding exactly to the primary content a consumer is consuming by enabling an unambiguous identification of the primary content by means of using the watermarking technology.

When setting up such a system of providing a consumer of streamed content with corresponding additional content, it is however of paramount importance to guarantee a reliable, unambiguous identification of the streamed content void or at least almost void of any misdetections in a fast and secure way.

The present invention addresses said problem of rendering additional content to a consumer of a streamed piece of audio content in a reliable, fast and secure way.

This object is solved by the subject matter of the independent claims. Preferred embodiments are defined by the dependent claims.

### SUMMARY

In the following, a summary is provided to introduce a selection of representative concepts in a simplified form that are further described below in the detailed description. This summary is not intended to identify key features or essential features of the claimed subject matter, nor is intended to be used in any way that would limit the scope of the appended claims.

Briefly, the subject matter of the present invention is directed towards a computer-implemented system and method for identifying a specific piece of audio content of a plurality of pieces of audio content and providing additional related content on a mobile device.

In a first step, an audio watermark is modulated onto each piece of audio content of the plurality of pieces of audio content, wherein the audio watermark comprises a unique identification number for each piece of audio content. Subsequently, said modulated pieces of audio content are stored on a streaming platform.

Further, in a method according to the present invention, a user has to open an identifying application on the mobile device, which is capable of identifying a specific piece of audio content and thus providing related additional content. Moreover, the user also has to open a third party—streaming application on the mobile phone and to play back a specific piece of audio content, while the identifying application remains open in the background.

Hence, the identifying application receives the specific played back piece of audio content by means of an audio signal receiver such as a microphone of the mobile device and subsequently demodulates it.

After having demodulated the received specific played back piece of audio content, the identifying application is further able to identify the specific played back piece of audio content based on the identification number comprised in the audio watermark.

Based on said identification, the identifying application is further able to retrieve a specific additional content, which corresponds to the identified specific piece of audio content and to finally render said specific additional content corresponding to the identified specific piece of audio content on a display of the mobile device.

In order to allow watermarking said plurality of pieces of audio content in a unique way, the first 40 seconds of the plurality of pieces of audio content are divided into five time intervals, in each of which a separate data signal of 10 bits is modulated on top of the carrier signal formed by the piece of audio content. Moreover, each of said separate data signals is modulated onto the carrier signal at least eight times within each of said five time intervals. In this way, it is made sure that each of said data signals is correctly identified even in the case of one or more failures occurring during the process of demodulating the audio signal.

In addition, in an embodiment of the present invention, the data signal modulated on the carrier signal in the first time interval is identical for each piece of audio content of the plurality of pieces of audio content. The identification of said so called start signal triggers the beginning of the actual process of identifying a specific piece of audio content based on demodulating the data signals corresponding to the second to fifth time intervals, which are characteristics for each piece of audio content of the plurality of pieces of audio content. In doing so, all data signals received before said start signal are ignored in the process of identifying a specific piece of audio content. Said start signal thus allows efficiently avoiding any erroneous identifications of a piece of audio content, which could be caused by starting a specific piece of audio content not from the beginning. Hence, the probability of performing a misdetection of a specific piece of audio content is greatly reduced by the inclusion of such an identical start signal for all of the plurality of pieces of audio content. Hence, a great reliability is achieved in the process of identifying a specific piece of audio content.

Moreover, in an embodiment according to the present invention, the process of trying to identify a played back specific piece of audio content is performed already after having received and demodulated merely the second or merely the second and the third data signal, instead of performing said identification only after having received and demodulated the data signals corresponding to all five time intervals. In this way, it is possible to significantly speed up the process of identifying a specific piece of audio content, since it is not necessary to wait until the data signals corresponding to all four (or five) time intervals have been received and demodulated. Hence, the additional content corresponding to the identified specific piece of audio content can be quickly rendered on the mobile device.

In a further attempt to realize a fast identification process for a specific piece of audio content, in embodiments of the present invention, a look-up table comprising a mapping between the identification numbers of the plurality of pieces of audio content and their corresponding additional contents is cached locally in the memory of a mobile device.

However, even when implementing said possibility of locally identifying a specific piece of audio content, it is made sure in embodiments of the present invention that the last part of the identification number of a specific piece of audio content corresponding to the data signal of the fifth time interval can only be verified by a server. Hence, the complete identification number has to be transmitted to a server for a final check and confirmation. By doing so, the overall security of a system and method according to the present invention is greatly enhanced, since it is made sure that a compromised application on the mobile device or a man-in-the-middle attack can be detected.

In addition, in order to further enhance the overall security, said last part of the identification number is transmitted from the mobile device to the server in the form of a hash generated from the identification number in the embodiments of the present invention.

Other advantages may become apparent from the following detailed description when taken in conjunction with the drawings.

### BRIEF DESCRIPTION OF THE DRAWINGS

The subject matter of the invention will be explained in more detail in the following text with reference to exemplary embodiments, which are illustrated in the attached drawings, of which:

FIG. 1 is a block diagram that shows the components of a system for dynamically providing additional content for a piece of audio content to be displayed on a mobile device according to embodiments of the present invention.

FIG. 2 depicts an example of a concrete implementation of a method according to the present invention as provided to a user on a mobile device.

FIG. 3 is a table explaining further technical details of the method steps of modulating audio watermarks comprising data signals onto a piece of audio content and of identifying said pieces of audio content.

FIG. 4 is a flow diagram that illustrates the different steps of a method according to the present invention for dynamically providing additional content for a specific piece of audio content to be rendered on a mobile device.

### DETAILED DESCRIPTION

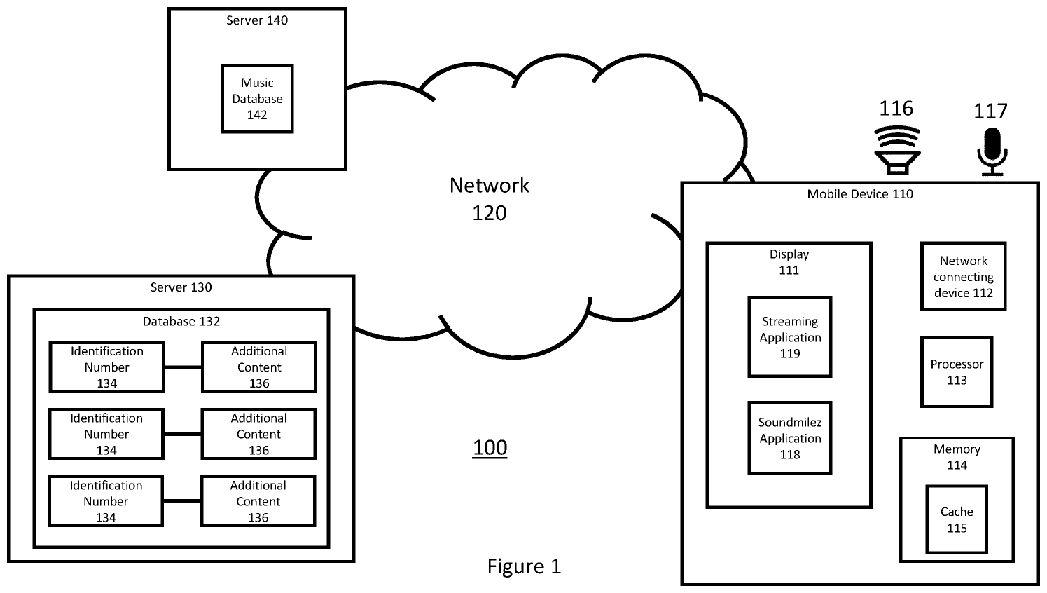

FIG. 1 shows an example implementation 100 of a system for providing additional content for a piece of music to be displayed on a mobile device according to embodiments of the present invention. Said system 100 includes a mobile device 110 such as a smartphone, a tablet, a PDA, a handheld computer, a smartwatch etc. However, these devices rather serve as illustrative examples of mobile devices and additional and/or further devices may also be used in the system 100 of the present invention.

The mobile device 110 comprises at least a display 111, a network connecting device 112 such as an antenna, a WIFI receiver etc., a memory 114 including a cache 115 and an audio signal transmitter 116 such as e.g. a loudspeaker and an audio signal receiver 117 such as e.g. a microphone. Hereby, the audio signal transmitter 116 and the audio signal receiver 117 may be separate devices or may be combined to form a single device.

Further, the mobile device 110 contains at least two applications that are presented to a user on the display 111. An identifying application 118 available on the mobile device 110 is capable of displaying additional content related to a specific audio content on the display 111 in response to identifying said specific audio content such as for example a piece of music received by the audio signal receiver 117 of the mobile device 110. An example for said identifying application 118 is the soundmilez application. A second streaming application 119 that is available on the mobile device 110 is a streaming application such as e.g. Spotify, iTunes, youtube etc., which is configured to play back audio content and/or combined audio and video content such as for example a specific piece of music. In the following, the description merely illustrates the case of said content being audio content for the sake of simplicity.

The mobile device 110 is connected by a network 120 such as for example a mobile communication network such as 4G, LTE, 5G, Internet, LAN, WIFI, etc. to at least two servers 130, 140. A first server 130 includes at least a database 132, in which look-up tables of identification numbers 134 of pieces of audio content mapped to additional content 136 corresponding to said pieces of audio content are stored. A second server 140 comprises at least a database 142, in which a plurality of pieces of audio content such as a plurality of pieces of music are stored. The streaming application 119 is configured to access said database 142 stored on the second server 140 for obtaining a specific audio content to be played back. While being shown in FIG. 1 as two separate servers 130, 140, the functionality of the first server 130 and the second server 140 may also be included into one single server, which is connected to the mobile device 110 via network 120.

The plurality of pieces of audio content that are stored in database 142 on the second server 140 have been modulated to include an audio watermark that comprises an identification number 134 that is unique for each of said pieces of audio content. Hereby, said audio watermark is non-audible and thus not recognizable by a human user when listening to a piece of audio content, which has been modulated by such an audio watermark.

When performing said modulation of the audio content, different modulation schemes, for example amplitude shift keying (ASK), amplitude modulation, frequency shift keying (FSK), frequency modulation and/or quadrature amplitude modulation (QAM) are utilized. QAM conveys message signals by modulating the amplitudes of two carrier waves using ASK and/or FSK. These two carrier waves of the same frequency are out of phase by 90°. The modulated waves are then summed and the resulting signal is a combination of phase-shift keying (PSK) and amplitude-shift keying (ASK). These modulation schemes, however, only serve as examples of modulation schemes. More particularly, alternative and/or additional modulation schemes, for example further digital modulation schemes, may be used for generating the resulting pieces of audio content, onto which an audio watermark has been modulated. In some example implementations, in particular a combination of several of these modulation schemes may apply, for example a combination of frequency FSK and amplitude shift keying ASK.

A user of the mobile device 110 may open both the identifying application 118 and the streaming application 119. He or she may then use the streaming application 119 to select a specific piece of audio content such as e.g. a specific piece of music he or she would like to listen to. Subsequently, the streaming application 119 retrieves said specific piece of audio content from the database 142 storing a plurality of pieces of audio content on the second server 140 and provides a command to the audio transmitter 116 of the mobile device 110 to play back said specific piece of audio content.

Said played back specific piece of audio content is at the same time received by the audio signal receiver 117 of the mobile device 110 and transmitted to the identifying application 118, which has remained open in the background on the mobile device 110. The identifying application 118 is capable to demodulate the specific played back piece of audio content and thus to identify the identification number 134 comprised in the audio watermark modulated onto the actual audio content.

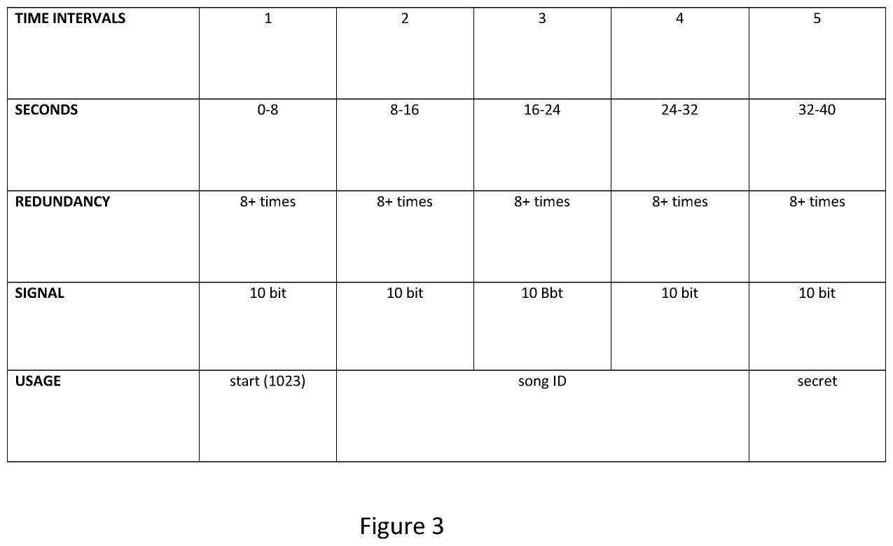

Further details regarding the structure of the audio watermark and the process of identifying the identification number 134 comprised in the audio watermark are described below with regard to FIG. 3.

The identifying application 118 further consults the look-up table comprising a mapping between identification numbers 134 of a plurality of pieces of audio content and additional content 136 stored in database 132 on the first server 130 in order to find a match for the identification number 134 identified from the audio watermark. Alternatively, such a look-up table or at least a part of it may also be cached by the identifying application 118 from the first server 130 and stored locally in a cache 115 in memory 114 of the mobile device 110.

When the identifying application 118 has found in the look-up table an identification number 134, which matches the identification number 134 identified from the received audio watermark, the identifying application 118 is configured to retrieve the additional content corresponding to the identified identification number 134 and to render the specific additional content 136 that is stored in the look-up table as corresponding additional content 136 for a specific identification number 134 of a specific identified piece of audio content on the display 111 of the mobile device 110.

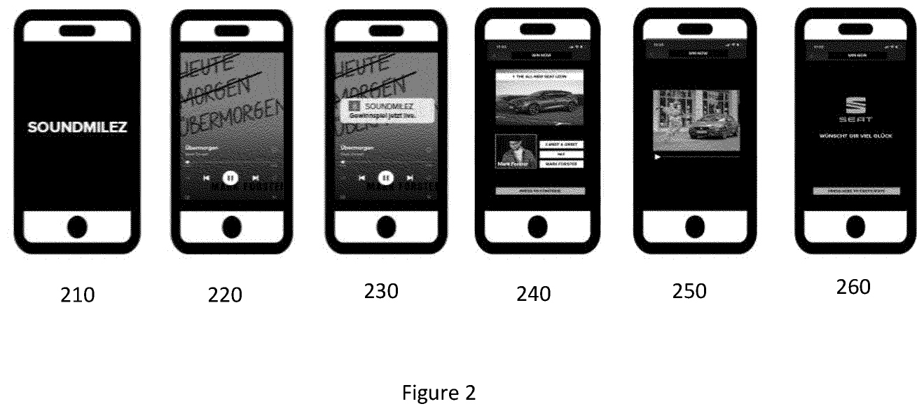

FIG. 2 illustrates an example for a typical process to be performed within the system 100 of FIG. 1 from the point of view of the user of the mobile device 110.

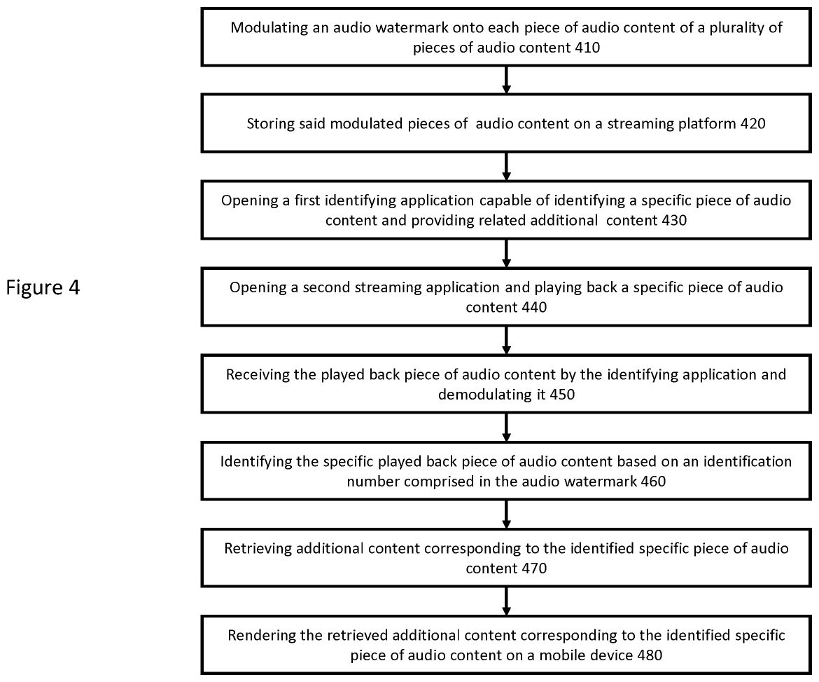

A first view 210 of the display 111 of the mobile device 110 shows the start screen of the identifying application 118 directly after a user has opened said identifying application 118. In this example of FIG. 2, said identifying application 118 is the soundmilez application. A second view 220 of the display 111 of the mobile device 110 depicts the streaming application 119, in which a specific audio content, in this example a specific song, is played back. In a third view 230 of the display 111 of the mobile device 110, a notification to a user originating from the identifying application 118 is shown as popping up within the streaming application 119. This notification informs a user of an additional content 136 corresponding to the song being played back by the streaming application 119 being now available. Such a notification directing a user to said additional content 136 for the specific, currently played back song is a direct outcome of the identifying application running in the background and having successfully identified the specific song played back by the streaming application 119 by means of carrying out the functionality described above with regard to FIG. 1 and detailed below with regard to FIG. 4. In the example of FIG. 2, said additional content 136 corresponding to the specific song being played back by the streaming application 119 refers to a competition, in which the user has to answer one or more questions relating to the artist of the song being played back by the streaming application 119 and may be rewarded with a prize.

Views 240 to 260 of display 111 of mobile device 110 depict further details regarding said additional content 136 presented to a user within the soundmilez application 118. In view 240, it is shown that a specific webpage relating to the competition opens within the soundmilez application 118. In order to continue, the user has to interact with the soundmilez application 118, e.g. by pressing a button on the mobile device 110. View 250 of the soundmilez application 118 shows a subsequent video advertisement of a sponsor of the competition, which is presented to the user within the soundmilez application 118. Once said video advertisement is finished, the user is again presented with a view 260 of the soundmilez application 118, which requires his or her interaction for example by means of pressing a button on the mobile device 110, in order to finally participate in the competition relating to the artist of the song being played back by the streaming application 119.

FIG. 3 further illustrates some more details regarding the marking of pieces of audio content with audio watermarks, which are not audible by a user, and the subsequent identification of the information comprised within said audio watermarks.

As mentioned before with regard to FIG. 1, a piece of audio content is used as a carrier signal, onto which an additional data signal is modulated in the form of the audio watermark. In the present invention, said additional data signal that is modulated onto the pieces of audio content has a length of 10 bit. A maximum length of said data signal of 10 bit has been empirically determined to be suitable for the watermarking technology of the present invention. Accordingly, merely numbers between 0 and 1023 can be encoded into said data signals.

For the purpose of the present invention, it is necessary that a piece of audio content is watermarked in such a way, that said piece of audio content can be uniquely and unambiguously identified based on the identification number comprised in the audio watermark signal. Hence, based on one of said data signals of a length of 10 bit, it would merely be possible to uniquely mark 1024 different pieces of audio content, which is not much, given the millions of pieces of audio content available in a database 142 of a streaming application 119.

Moreover, for a typical special use case to which the watermarking technology of the present invention is applied, it is important to make sure that a piece of audio content is at least consumed from the beginning, i.e. from second 0, until second 32. Namely, for both charts and streaming applications, a piece of audio content such as e.g. a song is merely considered as being consumed, if a user has listened to it during the first 30 seconds.

As it can be seen from FIG. 3, the present invention addresses said two constraints mentioned above by dividing the piece of audio content into four time intervals between seconds 0 and 32, and a fifth time interval starting at second 32, within each of which a separate watermark comprising a data signal is modulated onto the acoustic carrier signal of the piece of audio content. As each of said separate data signals has a maximum length of 10 bit, it is now feasible to uniquely mark a large amount of pieces of audio content encompassing the plurality of pieces of audio content stored in a database 142 of a streaming application, such as streaming application 119.

Said time intervals, into which the pieces of audio content are divided, do not necessarily have to be all of a same length. Many pieces of audio content are characterized by starting with parts of partial or even complete silence. Since it is however complicated or even impossible to modulate a watermark comprising a data signal on top of a weak or even absent carrier signal, the first time interval is often chosen to be larger than merely eight seconds. However, for the sake of simplicity of explanation, the time intervals shown in FIG. 3 are all of a same length of eight seconds.

Within each of said five time intervals, the carrier signal of the piece of audio content is marked with the watermark comprising a data signal as often as possible. The exact frequency, with which a specific audio watermark comprising a data signal is thus transmitted within one of said five time intervals, again depends to some extent on the character of the carrier signal provided by the specific piece of audio content. As a rule, it is however in general feasible to modulate such a 10 bit data signal onto a piece of audio content every 0.3 to 1.2 seconds. Therefore, on average, it is possible to transmit at least eight of such data signals within each time interval.

In what follows, more details about how the identifying application 118 as shown in FIG. 1 identifies a specific piece of audio content are described.

As it can be seen from the last rows of FIG. 3, the five different data signals, which are modulated on top of the carrier signal given by a piece of audio content, are used to fulfil different tasks depending on the specific time interval to which they refer.

During the first time interval, a same start signal corresponding to the number 1023 is always modulated on top of the carrier signal and thus transmitted for all of the plurality of pieces of audio content comprised in the database 142 of the second server 140. Said start signal being identical to all of the plurality of pieces of audio content triggers the beginning of the step of identifying a specific piece of audio content by the identifying application 118. Thus, the usage of an identical start signal to be modulated onto all pieces of audio content guarantees that the identifying application 118 starts the process of identifying a specific piece of audio content merely after having received said identical start signal. Hence, all signals received by the audio receiver 117 of the mobile device 110 before said fixed start signal are ignored by the identifying application 118 in the process of identifying a specific piece of audio content. Said start signal thus allows to efficiently avoid any erroneous identifications of a piece of audio content, which could be caused by starting a specific piece of audio content not from the beginning.

As an example, without the usage of a fixed start signal, a specific piece of audio content characterized by the identification number 2.3.4.5.6 could be confused with another specific piece of audio content characterized by the identification number 1.2.3.4.5, if the latter specific piece of audio content is started slightly too late so that the first data signal corresponding to the first time interval is missed and thus cannot be identified.

It must be emphasized that the usage of an identical start signal still does not completely eliminate the risk of a misdetection of a specific piece of audio content. Namely, it is still possible that a specific piece of audio content is started from the beginning and that subsequently a valid identification number is generated by jumping to different positions within the specific piece of audio content, which is identical to the correct identification number of a different piece of audio content. However, the overall probability of such a misdetection of a specific piece of audio content is merely 1/1022⁴, i.e. 1/10¹². Hence, the method of the present invention for correctly identifying a specific piece of audio content is highly reliable.

Further, the watermarks comprising the data signals modulated onto an acoustic carrier signal constituted by a piece of audio content during the second, third and fourth time interval, respectively, are characteristics for each piece of audio content of the plurality of pieces of audio content and relate to identification numbers for unambiguously identifying a specific piece of audio content.

In a preferred embodiment of the present invention, the identifying application 118 is configured to check locally after having received, demodulated and identified each single, one of said three data signals corresponding to the second, third and fourth time interval, respectively, whether it is already feasible to unambiguously identify a specific piece of audio content. Performing such checks after each identified number of the identification number allows a much faster detection of a specific piece of audio content compared to performing a comparison with the cached identification numbers merely after the complete identification number has been received and identified by the identifying application 118. In such an embodiment of the present invention, the additional content relating to a specific piece of audio content has to be readily available within a cache 115 on the mobile device 110. Said cache 115 hereby includes a look-up table between the identification numbers of the plurality of pieces of audio content and their corresponding additional contents in the same way as database 132 of the first server 130. As soon as a received specific piece of audio content has been correctly identified by the identifying application 118 based on the data signal modulated on top of the specific piece of audio content within the second time interval, or the data signals modulated on top of the specific piece of audio content within the second and third or within the second, third and fourth time interval, the cached additional content corresponding to the identified specific piece of audio content is readily presented to a user within the identifying application 118 on the display 111 of the mobile device 110.

The watermark comprising the data signal modulated on top of the acoustic carrier signal constituted by a piece of audio content during the fifth time interval comprises the last part of the identification number, which is unknown to the identifying application 118. Therefore, the identifying application 118 cannot verify said last part of the identification number itself by means of comparing it to the plurality of identification numbers of a plurality of pieces of audio content stored in a cache 115 in the memory 114 of the mobile device 110. Instead, said last part of the identification number modulated on top of the piece of audio content within the fifth time interval is a secret, which can merely be verified by the first server 130. Hence, in an embodiment of the present invention, after having received and decoded the parts of the identification number referring to all five data signals modulated onto a piece of audio content within the five time intervals described above, the complete identification number is transmitted to the first server 130 for a final check and confirmation. This way, the overall security of the described system 110 according to the present invention is greatly enhanced, since it is made sure that a compromised identifying application 118 or a man-in-the-middle attack can be detected. Such attacks could for example result in the generation of an arbitrary number of participations in the competition without having played back the specific piece of audio content, if reference is again made to the example described in FIG. 2 above. Said secret is only known to the first server 130 and obviously comprised in an encoded form in the piece of audio content. Further, in order to avoid that the secret being identified by the identifying application 118 is transmitted via network 120 to the first server 130, the secret is instead transmitted from the identifying application 118 to the first server 130 in the form of a hash generated from the identification number. In contrast hereto, the part of the identification number corresponding to the first four data signals is transmitted as plain text to the first server 130.

In the following, a short example for the functioning of said security feature in the present invention is described. In said example, it is assumed that the identifying application 118 has identified the identification number 1023.1.2.3.5 from the received and subsequently demodulated piece of audio content. Locally, i.e. on the mobile device 110, the identifying application 118 is only able to compare the first four received and identified numbers of the identification number 1023.1.2.3 with the identification numbers stored in the cache 115 of the memory 114. Namely, the cache 115 does not contain any information regarding the fifth number of the identification number 1023.1.2.3.5, which is the secret. Therefore, the identifying application 118 generates a hash of 1023.1.2.3.5 and of further data and subsequently transmits the first four numbers 1023.1.2.3 as plain text together with the generated hash to the first server 130 over the network 120. Hence, when applying said method, the number 5 of the secret is neither stored locally in the cache 115 of the memory 114 on the mobile device 110 nor being transmitted over the network 120.

FIG. 4 is a flow diagram illustrating the single steps of the method for identifying a specific piece of audio content of a plurality of pieces of audio content and providing additional content related to said identified specific piece of audio content on a display 111 of a mobile device 110.

As can be seen from FIG. 4, in a first method step 410, an audio watermark is modulated onto each piece of audio content of the plurality of pieces of audio content. Hereby, the audio watermark comprises a data signal containing a unique identification number for each piece of audio content, which is modulated onto a carrier signal formed by the piece of audio content.

In a next method step 420, said modulated pieces of audio content are stored on a streaming platform such as e.g. Spotify, iTunes, youtube etc.

Subsequently, in step 430, an identifying application 118 is opened by a user on a mobile device 110. Said identifying application 118 has to have the characteristics of being capable of recognizing a specific piece of audio content such as for example a specific piece of music received by the audio signal receiver 117 of the mobile device 110 and of providing additional content related to a specific piece of audio content to the user of the mobile device 110.

In a further step 440, a second streaming application 119 is opened by a user on the mobile device 110, and a specific piece of audio content is selected to be played back. It is important that when carrying out step 440 of the method according to the present invention, the identifying application 118 remains open in the background on the mobile device 110.

The identifying application 118 further receives the played back piece of audio content by means of the audio signal receiver 117 of the mobile device 110 and demodulates the specific played back piece of audio content in step 450 of the method according to the present invention.

Further, the identifying application 118 identifies the specific played back piece of audio content based on an identification number comprised in the audio watermark in step 460. In more detail, the identifying application 118 compares the identification number extracted from the audio watermark to the identification numbers of a plurality of pieces of audio content stored either locally on a cache 115 of memory 114 of the mobile device 110 or remotely in a database 132 of a first server 130.

In a next step 470, the identifying application 118 also retrieves the specific additional content corresponding to the identified specific piece of audio content. This is done by the identifying application 118 consulting a look-up table between the identification numbers of the plurality of pieces of audio content and their corresponding additional contents. Said look-up table is hereby either stored locally on a cache 115 of memory 114 of the mobile device 110 or remotely in a database 132 of a first server 130.

Finally, in a last step 480 of the method according to the present invention, the identified specific additional content corresponding to the identified specific piece of audio content is rendered in the identifying application 118 on the display 111 of the mobile device 110.

From the forgoing and further it will be appreciated that, although specific embodiments have been described herein for purposes of illustration, various modifications may be made without deviating from the scope of the present disclosure. For example, the methods, techniques, computer-readable medium, and systems for identifying a specific piece of audio content of a plurality of pieces of audio content and providing additional related content on a mobile device discussed herein are applicable to other architectures and other system architectures than the ones depicted.

1. A method for identifying a specific piece of audio content of a plurality of pieces of audio content and providing additional related content on a mobile device, the method comprising:
modulating an audio watermark onto each piece of audio content of the plurality of pieces of audio content, wherein the audio watermark comprises a unique identification number for each piece of audio content;
storing said modulated pieces of audio content on a streaming platform;
opening a first identifying application on the mobile device, wherein the identifying application is configured to be capable of identifying a specific piece of audio content and providing related additional content;
opening a second streaming application on the mobile device and playing back a specific piece of audio content, wherein the identifying application remains open in the background;
receiving and demodulating, by the identifying application, the specific played back piece of audio content;
identifying, by the identifying application, the specific played back piece of audio content based on the identification number comprised in the audio watermark;
retrieving, by the identifying application, a specific additional content corresponding to the identified specific piece of audio content; and
rendering the specific additional content corresponding to the identified specific piece of audio content on a display of the mobile device.

2. The method of claim 1, wherein modulating the audio watermark onto each piece of the plurality of pieces of audio content comprises dividing the first 40 seconds of each piece of audio content into five time intervals and modulating a data signal onto each piece of audio content in each of said five intervals at least eight times.

3. The method of claim 2, wherein each of said data signals has a size of 10 bits.

4. The method of claim 2, wherein the five time intervals are of a same or of a different size.

5. The method of claim 2, wherein the data signal of the first time interval comprises a start signal being identical for each piece of audio content of the plurality of pieces of audio content and is configured to trigger the step of identifying the specific piece of audio content by the first application, and wherein the data signals of the second to fifth time intervals are characteristic for each piece of audio content of the plurality of pieces of audio content.

6. The method of claim 2, wherein identifying the played back specific piece of audio content is based on the identifying application consulting a cache including a look-up table between the identification numbers of the plurality of pieces of audio content and their corresponding additional contents on the mobile device.

7. The method of claim 6, wherein identifying the played back specific piece of audio content by the identifying application comprises trying to perform said identification already after receiving and demodulating merely the second or merely the second and the third data signal; and
if said identification is already possible, rendering the specific additional content corresponding to the identified specific piece of audio content in the identifying application on the mobile device.

8. The method of claim 2, wherein the last part of the identification number corresponding to the data signal of the fifth interval is unknown to the identifying application and is transmitted to a server for a confirmation.

9. The method of claim 8, further comprising:
after receiving and demodulating all five data signals, transmitting the complete identification number to the server, wherein the part of the identification number corresponding to the first four data signals is transmitted as plain text and the last part of the identification number corresponding to the fifth data signal is transmitted in the form of a hash generated from the identification number.

10. A system for identifying a specific piece of audio content of a plurality of pieces of audio content and providing additional related content on a mobile device, the system comprising:
a first server comprising a database configured to store a plurality of pieces of audio content modulated to include an audio watermark comprising a unique identification number;
a second server comprising a database configured to store a look-up table between identification numbers of a plurality of pieces of audio content and corresponding additional content;
a network configured to connect the first server and the second server to a mobile device;
the mobile device comprising a first identifying application and a second streaming application on a display, an audio signal transmitter and an audio signal receiver, and configured to:
play back a specific piece of audio content from the database by means of the audio signal transmitter in response to opening the second music stream application;
receive the played back specific piece of audio content by means of the audio signal receiver in response to opening the identifying application;
demodulate the specific played back piece of audio content;
identify the specific played back piece of audio content based on the identification number comprised in the audio watermark;
retrieve a specific additional content corresponding to the identified specific piece of audio content; and
render the specific additional content corresponding to the identified specific piece of audio content on the display.

11. The system of claim 10, wherein the audio watermark comprises five data signals modulated onto each piece of audio content within five time intervals at least eight times.

12. The system of claim 11, wherein each of said data signals has a size of 10 bits.

13. The system of claim 11, wherein the five time intervals are of a same or of a different size.

14. The system of claim 11, wherein the data signal of the first time interval comprises a start signal being identical for each piece of audio content of the plurality of pieces of audio content and is configured to trigger the identification process of the specific piece of audio content, and wherein the data signals of the second to fifth time intervals are characteristic for each piece of audio content of the plurality of pieces of audio content.

15. The system of any of claim 11, to wherein the mobile device is further configured to identify the played back specific piece of audio content based on consulting a cache including a look-up table between the identification numbers of the plurality of pieces of audio content and their corresponding additional contents comprised in the memory of the mobile device.

16. The system according to claim 15, wherein the mobile device is configured to try to identify the played back specific piece of audio content already after receiving and demodulating merely the second or merely the second and the third data signal and further to render the specific additional content corresponding to the identified specific piece of audio content on the display, if the identification has been possible.

17. The system according to claim 11, wherein the mobile device is unable to verify a last part of the identification number corresponding to the data signal of the fifth time interval and thus is configured to transmit said last part of the identification number to the second server for performing a confirmation.

18. The system according to claim 17, wherein the mobile device is further configured to transmit the part of the identification number corresponding to the first four data signals as plain text and the last part of the identification number corresponding to the fifth data signal in the form of a hash generated from the identification number.

19. A computer-readable medium having stored thereon computer-readable instructions that, when run on a computer, are configured to perform the steps of claim 1.
